(19) United States
(12) Patent Application Publication
(10) Pub. No.: US 2007/0298178 A1
(43) Pub. Date: Dec. 27, 2007

(54) Two Packages Type Thermosetting Resin Composition, Film Forming Method and Coated Article

(76) Inventors: Hisaki Tanabe, Osaka (JP); Hideaki Tsujioka, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/592,385

(22) PCT Filed: Mar. 11, 2005
(86) PCT No.: PCT/JP05/04347

§ 371 Date: Jun. 11, 2007

(30) Foreign Application Priority Data
Mar. 12, 2004 (JP) 2004-071260
May 14, 2004 (JP) 2004-144881

(51) Int. Cl. C08L 63/00; B05D 1/36; B05D 7/24; C08G 59/32; C08G 59/40

(52) U.S. Cl. 427/372.2; 525/111

(57) ABSTRACT

The great decrease of the curing time (in particular, halving) of acid/epoxy curing system paint and the further improvement of other performances (in particular, film performance). A two packages type thermosetting resin composition comprising (a) an acid anhydride group-containing acryl resin having an acid anhydride group of 0.08 to 5.3 mmol/g (solid content) and a number average molecular weight of 500 to 8000 that is obtained by copolymerizing an acid anhydride group-containing ethylenically unsaturated monomer with an ethylenically unsaturated monomer having no acid anhydride group, (b) a carboxylic group-containing polyester resin having a carboxylic group of 0.8 to 6.3 mmol/g (solid content) and a number average molecular weight of 400 to 3500 and a ratio of weight average molecular weight to number average molecular weight of 1.8 or less that is obtained by reacting an acid anhydride group-containing ethylenically unsaturated monomer with polyester polyol having 3 or more of hydroxyl groups, and (c) an acryl resin with hydroxyl groups and epoxy groups having a hydroxyl group of 0.08 to 5.4 mmol/g (solid content), an epoxy group of 1.2 to 10.0 mmol/g (solid content) and a number average molecular weight of 200 to 10000 that is obtained by copolymerizing a hydroxyl group-containing ethylenically unsaturated monomer and an epoxy group-containing ethylenically unsaturated monomer with an ethylenically unsaturated monomer not having a hydroxyl group and an epoxy group.

### TECHNICAL FIELD

The present invention relates to a two packages type thermosetting resin composition, a film forming method using thereof and a coated article.

### BACKGROUND ART

A colored film and a clear paint thereon are formed on a coated article such as an automobile. It was previously general to use a polymer containing a hydroxyl group as a binder resin for the clear paint of the outermost layer and to use a melamine resin curing agent in order to cure it. However, the cured film using the melamine resin as a curing agent had a defect inferior in acid resistance that is deduced to originate in the triazine nuclei of the melamine resin. The melamine curing system using the melamine resin is weak in acidic rain which has been recently a problem and the development of an alternative technique has been required.

A technique developed in place of the melamine curing system being weak in acid resistance was a technique using an acid/epoxy curing system using the reaction of an acid group with an epoxy group. Since the reaction of an acid group with an epoxy group has been known from a long time ago, there have been many prior arts. For example, there have been U.S. Pat. No. 4,681,811 (the patent literature 1), U.S. Pat. No. 4,816,500 (the patent literature 2) and the like.

The present inventors have improved these old techniques and completed patent group based on JP No. 3243165 (the patent literature 3), JP-A-8-100149 (the patent literature 4) and the like to be presently used as clear paints for many automobiles. The portion being the basis of the technique was a curing technique based on a reaction where a highly reactive acid anhydride group is half-esterified and a acid anhydride group is regenerated by closing a ring at heat-curing thereof. The reaction is represented by the chemical formula below.

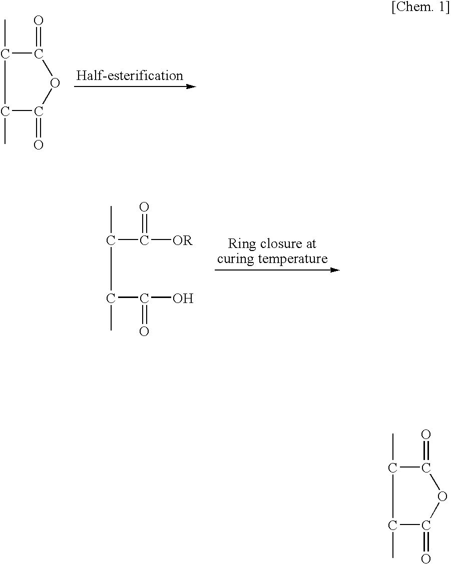

The half-esterification has been used for preparing one package type paint that can be easily handled by stabilizing an acid anhydride group with essentially high reactivity. However, as described in the Kyoto Protocol, from the viewpoint of the emission control of carbon dioxide for preventing global warming and resource saving, heat amount used during curing paint has been required to be reduced. Although the application line of automobiles and the like moves a coated article at a constant speed, and a method for moving the coated articles in a long heating furnace with a length of 100 to 150 meters at heat-curing is employed. In plain words, the decrease of heat amount is that the length of the heating furnace is shortened and it is particularly considered that the purpose is to shorten the length by half. The demand is required to be attained from various technical viewpoints but it can be also attained by reducing the curing time by half with thinking about paint.
Patent literature 1: U.S. Pat. No. 4,681,811
Patent literature 2: U.S. Pat. No. 4,816,500
Patent literature 3: JP No. 32431656
Patent literature 4: JP-A-8-100149

### DISCLOSURE OF THE INVENTION

### PROBLEMS TO BE SOLVED BY THE INVENTION

An object of the present invention is to largely reduce the curing time (in particular, halving) and further improve other performances (in particular, film performance) in the technology of the acid/epoxy curing system which has been highly evaluated in acid resistance.

### MEANS FOR SOLVING PROBLEMS

Namely, the present invention provides a two packages type thermosetting resin composition comprising:
(a) an acid anhydride group-containing acryl resin having an acid anhydride group of 0.08 to 5.3 mmol/g (solid content) and a number average molecular weight of 500 to 8000 that is obtained by copolymerizing an acid anhydride group-containing ethylenically unsaturated monomer with an ethylenically unsaturated monomer having no acid anhydride group,
(b) a carboxylic group-containing polyester resin having a carboxylic group of 0.8 to 6.3 mmol/g (solid content), a number average molecular weight of 400 to 3500, and a ratio of weight average molecular weight to number average molecular weight of 1.8 or less that is obtained by reacting an acid anhydride group-containing compound with polyester polyol having 3 or more of hydroxyl groups, and
(c) an acryl resin with hydroxyl groups and epoxy groups having a hydroxyl group of 0.08 to 5.4 mmol/g (solid content), an epoxy group of 1.2 to 10.0 mmol/g (solid content) and a number average molecular weight of 200 to 10000 that is obtained by copolymerizing a hydroxyl group-containing ethylenically unsaturated monomer and an epoxy group-containing ethylenically unsaturated monomer with an ethylenically unsaturated monomer not having a hydroxyl group and an epoxy group.

In the composition, the components (a) and (b) are the first package, the component (c) is the second package and both packages are preferably mixed before coating so that the equivalent ratio of an acid anhydride group component contained in the first package to an epoxy group component contained in the second package is 2/1 to 1/2.

Either of the first or the second packages or both packages generally contain a curing catalyst (d).

As a compounding amount of the respective components, it is preferable that the component (a) is 20 to 60% by weight, the component (b) is 40 to 70% by weight, the component (c) is 3 to 30% by weight and the component (d) is 0.1 to 5.0% by weight (provided that % by weight is a value setting the total solid content weight of the components (a) to (d) as 100%).

Further, the present invention provides a coating film forming method comprising a step of coating an aqueous base or a solvent base paint on an under-coated or middle-coated substrate, a step of coating the two packages type thermosetting resin composition thereon without curing the base coating film, and a step of curing the base coating film and the two packages type thermosetting resin composition by heating.

The present invention also provides a coated article obtained by the above method.

### FUNCTION OF THE INVENTION

In the present invention, as a result, a two packages type paint is prepared from a one package type thermosetting resin composition by using a highly reactive acid anhydride group as it is without the half-esterification reaction of the acid anhydride group of an acid/epoxy curing system that has been developed by the present applicants, but many discussions and devises have been practically required. Specifically, it is linked with the speed up of curing not to carry out a technique for weakening reactivity, which used for preparing one package type paint (“reactivity inhibiting technique”, here, it is equivalent to the half-esterification), but there have been many problems as the curing system of a coating film for automobiles. For example, since reactivity is too high and reaction proceeds too rapid, defects of appearance (generation of wrinkle) occur. Rapid reaction is difficult to be controlled and therefore cannot be applied to actual coating system unless other technique is sufficiently considered and carefully employed. Further, to the contrary, even if the reactivity inhibiting technique is not carried out, reaction time cannot be occasionally shortened adequately without the combination of resins and the devise of amount of functional groups from the viewpoint of the film physical property of coating film obtained. In the present invention, it has been experimentally verified that even if a two packages type paint is prepared without carrying out the half-esterification, the reaction time is considerably controlled and even if curing time is shortened to about a half, a coating film with adequate physical property is obtained. It is also surprised that, when the composition is used as a clear paint and is applied to a base coating film by wet-on-wet, striking the case coating film of the under layer into the clear coating film can be suppressed and the finishing appearance of the coating film is remarkably improved. It is believed that the acid anhydride group-containing acryl polymer (a) is lower polarity than an acryl polymer half-esterified and the striking of the base coating film into the clear coating film can be prevented.

### TECHNICAL EFFECT OF THE INVENTION

In the present invention, as described above, although it is not advantageous in handling that the one package type paint is changed to the two packages type paint, the curing time of paint can be reduced to about a half in order to prevent environmental destruction at global scale and necessary heat amount for a curing furnace by heating can be also reduced to about a half. Further, the line length of the curing furnace can also be reduced to a half in view of the fact that the heat amount to be necessary for curing is reduced to be a half. This also causes space for curing smaller and designing of curing line easier.

### DETAILED DESCRIPTION OF THE INVENTION

Acid Anhydride Group-containing Acryl Polymer (a)

The acid anhydride group-containing acryl polymer (a) used in the thermosetting resin composition of the present invention can be obtained by copolymerizing an acid anhydride group-containing ethylenically unsaturated monomer with an ethylenically unsaturated monomer having no acid anhydride group and is preferably a resin having an average of 2 or more of acid anhydride groups in one molecule. It has more preferably 2 to 15 acid anhydride groups. When the acid anhydride group contained in one molecule is less than 2, the curing property of the coating composition is insufficient. When it is more than 15, it is hard and too brittle and is insufficient in weather resistance.

Further, the amount of the acid anhydride group in the acid anhydride group containing acryl polymer (a) is preferably 0.08 to 5.3 mmol/g (solid content), more preferably 0.4 to 4.5 mmol/g (solid content) and particularly preferably 0.8 to 3.6 mmol/g (solid content). When the amount of the acid anhydride group is less than the low limit, the curing property is insufficient and when it is more than the upper limit, the coating film obtained is hard and too brittle and is insufficient in weather resistance.

Further, the number average molecular weight is preferably 500 to 8000. The acid anhydride group-containing acryl polymer having 800 to 6000 is more preferable and the polymer having 1500 to 4000 is particularly preferable. When the molecular weight is less than the low limit, the curing property is insufficient and when it is more than the upper limit, the compatibility of mutual resins is deteriorated and appearance is deteriorated.

The acid anhydride group-containing acryl polymer is obtained by copolymerizing 5 to 80% by weight of the acid anhydride group-containing ethylenically unsaturated monomer with 20 to 95% by weight of the ethylenically unsaturated monomer having no acid anhydride group by known methods. It is obtained by copolymerizing preferably 10 to 60% by weight and more preferably 15 to 40% by weight of the acid anhydride group-containing ethylenically unsaturated monomer with 40 to 90% by weight and more preferably 60 to 85% by weight of the ethylenically unsaturated monomer having no acid anhydride group. When the amount of the acid anhydride group-containing ethylenically unsaturated monomer is less than the low limit, the curing property is insufficient and when it is more than the upper limit, the coating film obtained is hard and too brittle and is insufficient in weather resistance.

For example, the copolymerization can be carried out at polymerization temperature of 80 to 200° C. and polymerization time of 3 to 10 hours under normal pressure or pressurization using 0.5 to 20 parts by weight of an azo initiator or a peroxide initiator as a radical polymerization initiator based on 100 parts by weight of the total of the ethylenically unsaturated monomers. At the same time, a chain transfer agent, a coloring prevention agent and the like may be added.

The specific example of the acid anhydride group-containing ethylenically unsaturated monomer includes itaconic anhydride, maleic anhydride, citraconic anhydride and the like. They are used because the curing property of a coating film is superior and the acid resistance of the coating film obtained is improved.

The ethylenically unsaturated monomer having no acid anhydride group is not specifically limited so far as it does not affect the acid anhydride group and is preferably a monomer with 3 to 15 carbon atoms and particularly preferably 3 to 12 carbon atoms that has one ethylenically unsaturated bond. A mixture of two or more kinds of ethylenically unsaturated monomers can be also used as the ethylenically unsaturated monomer having no acid anhydride group, because it is effective for improving the compatibility of mutual resins.

Further, as the ethylenically unsaturated monomer having no acid anhydride group, an ethylenically unsaturated monomer containing a carboxyl group can be used and monomers having a carboxyl group such as acrylic acid, methacrylic acid, itaconic acid and maleic acid can be used. Among these, when long chain carboxylic acid monomer having a spacer portion with 5 to 20 carbon atoms between a carboxyl group and an ethylenically unsaturated group such as the adduct of these with ε-caprolactone (for example, Aronix M-5300) is used, the scratch resistance of the coating film is preferably improved.

Further, the adduct of the acid anhydride group-containing compound with the ethylenically unsaturated monomer having a hydroxyl group represented by the formula (1) described later can be mentioned. These can be used alone or in combination with two or more. The acid anhydride group-containing compound provides carboxyl functionality by half-esterifying with a hydroxyl group at reaction conditions of room temperature to 150° C. and normal pressure. Here, the acid anhydride group-containing compound having 4 to 12 carbon atoms and particularly preferably 8 to 10 carbon atoms that has a cyclic (unsaturated or saturated) group is preferably used. When the compound is used, the compatibility of the resin obtained is good.

Specifically, a carboxyl group-containing ethylenically unsaturated monomer obtained by half-esterifying the hydroxyl group-containing ethylenically unsaturated monomer with the acid anhydride group-containing compound in amount to provide a molar ratio of a hydroxyl group to an acid anhydride group of 1/0.5 to 1/1.0 and preferably 1/0.8 to 1/1.0 can be used as the ethylenically unsaturated monomer having no acid anhydride group. When the molar ratio is more than 1/0.5, the viscosity of the polymer is heightened and workability is bad. When it is less than 1/1.0, the excessive acid anhydride group-containing compound remains and the water resistance of a coating film is deteriorated.

The carbon number of the hydroxyl group-containing ethylenically unsaturated monomer used here is preferably 5 to 23 and more preferably 5 to 13. When the chain length is too short, flexibility around crosslinking points is lost, and thus it is too hard and when the chain is too long, molecular weight between the crosslinking points is too large. In general, the hydroxyl group-containing ethylenically unsaturated monomer having a structure represented by the formula:

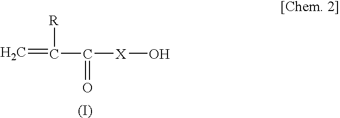

[Wherein R is a hydrogen atom or a methyl group and X is an organic chain represented by the formula:

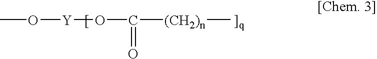

(Wherein Y is a linear chain or branched chain alkylene group with 2 to 8 carbon atoms and q is an integer of 0 to 4.), or an organic chain represented by the formula:

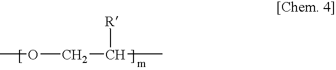

(Wherein R is a hydrogen atom or a methyl group and m is an integer of 2 to 50.)] is mentioned. The specific example includes compounds such as 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate and reaction products with these ε-caprolactones and compounds which can be prepared by esterifying (meth)acrylic acid with excessive diols (for example, 1,4-butanediol, 1,6-hexanediol, polyethylene glycol and polypropylene glycol).

These compounds are commercially available and for example, 4-hydroxybutyl acrylate “4HBA”, 4-hydroxybutyl methacrylate “4HBMA” and the like which are manufactured by Mitsubishi Chemical Corporation and “PLACCEL FM1”, “PLACCEL FA1” and the like which are manufactured by Daicel Chemical Industries Ltd. are mentioned. As a propylene oxide base monomer, “BLEMMER PP-1000” and “BLEMMER PP-800” manufactured by NOF Corporation are mentioned and as an ethylene oxide base monomer, “BLEMMER E-90” is mentioned.

The specific example of the acid anhydride group-containing compound used includes phthalic anhydride, tetrahydrophthalic anhydride, hexahydrophthalic anhydride, 4-methylhexahydrophthalic anhydride, trimellitic anhydride, succinic anhydride and the like.

The half-esterification reaction of the hydroxyl group-containing ethylenically unsaturated monomer with the acid anhydride group-containing compound is carried out at from room temperature to a temperature of 150° C. according to a usual method.

The specific example of the ethylenically unsaturated monomer having no acid anhydride group includes styrene, α-methylstyrene, p-tertert-butylstyrene, (meth)acrylic acid ester such as for example, methyl (meth)acrylate, ethyl (meth)acrylate, propyl (meth)acrylate, n-butyl (meth)acrylate, iso-butyl (meth)acrylate, tert-butyl (meth)acrylate, 2-ethylhexyl (meth)acrylate, lauryl (meth)acrylate, cyclohexyl (meth)acrylate, isobornyl (meth)acrylate, Veova-9 and Veova-10 manufactured by Shell Oil Co., Ltd. and the like. When styrene and a styrene derivative are used as the ethylenically unsaturated monomer having no carboxyl group, an amount of 5 to 40% by weight is preferably used.

The component of the acid anhydride group-containing acryl resin (a) can be compounded in the thermosetting resin composition at an amount of 10 to 70% by weight, preferably 15 to 50% by weight and more preferably 20 to 45% by weight based on the basis of the weight of the total solid content in the thermosetting resin composition. When the compounding amount of the component of the acid anhydride group-containing acryl resin (a) is less than 10% by weight, the acid resistance of a coating film obtained is deteriorated and when it is more than 70% by weight, the coating film is too hardened.

Carboxylic Group-containing Polyester Resin (b)

The carboxylic group-containing polyester resin (b) used for the thermosetting resin composition of the present invention is obtained by half-esterifying an acid anhydride group-containing compound with polyester polyol having 3 or more hydroxyl groups. In the present specification, the “polyester polyol” means polyvalent alcohol having 2 or more ester bond chains. Further, the polyvalent alcohol means alcohol having 2 or more hydroxyl groups.

The polyester polyol used herein is reacted with the acid anhydride group-containing compound to provide a carboxylic group-containing polyester resin having 2 or more acid functionalities and the under-mentioned properties.

In general, the polyester polyol is prepared by condensing a low molecular weight polyvalent alcohol having 3 to 16 carbon atoms and at least three hydroxyl groups, with a linear aliphatic dicarboxylic acid. Flexibility is provided for the coating film obtained by introducing linear aliphatic groups into the low molecular weight polyvalent alcohol and impact resistance is improved.

The low molecular weight polyvalent alcohol which may be used includes trimethylolpropane, trimethylolethane, 1,2,4-butanetriol, di(trimethylol)propane, pentaerythritol, dipentaerythritol, glycerin and a mixture thereof.

As the dicarboxylic acid, there can be also used dibasic acids such as phthalic acid, isophthalic acid, terephthalic acid, succinic acid, adipic acid, azelaic acid, sebacic acid, tetrahydrophthalic acid, hexahydrophthalic acid, maleic acid, fumaric acid and a mixture thereof. Further, there can be used the acid anhydride group-containing compounds such as succinic anhydride, phthalic anhydride, tetrahydrophthalic anhydride, hexahydrophthalic anhydride, hymic anhydride, trimellitic anhydride, methylcyclohexenetricarboxylic anhydride, pyromellitic anhydride and a mixture thereof.

The polyester polyol is synthesized by usual half-esterification reaction. Namely, it is polyesterified by the dehydration condensation reaction of a polyvalent alcohol with a polybasic acid or the esterification of a polyvalent alcohol with an acid anhydride group-containing compound and further dehydration reaction with an alkyl component. The oligomer of a comparatively low molecular weight polyvalent alcohol is obtained by the operation and the coating composition with high solid is provided.

The polyester polyol which is particularly preferable for use in the present invention is obtained by adding a lactone compound such as ε-caprolactone to the low molecular weight polyvalent alcohol to elongate the chain. Since molecular weight distribution is sharp, the high solidification of the coating composition is further enabled and the coating film superior in weather resistance and water resistance is obtained. The low molecular weight polyvalent alcohol which is particularly preferable in this case includes trimethylolpropane, di(trimethylol)propane, pentaerythritol and the like.

The “lactone compound” used in the present invention may be a cyclic compound that reacts with a nucleophilic agent because of having an oxygen atom in the ring to ring-open, generating a hydroxyl group at the terminal. The preferable lactone compound is a compound having 4 to 7 carbon atoms because it provokes easily ring opening addition reaction. Specifically, ε-caprolactone, γ-caprolactone, γ-valerolactone, δ-valerolactone, γ-butyrolactone and the like are mentioned, but ε-caprolactone, γ-valerolactone and γ-butyrolactone are preferably used.

The chain elongation can be carried out under a condition similar as the usual ring opening addition reaction. For example, a polyester polyol in which the chain of the low molecular weight polyvalent alcohol is elongated is obtained by reacting it at a temperature of 80 to 200° C. within 5 hours in an appropriate solvent or in non solvent. A tin base catalyst and the like may be used.

At that time, the molar amount of the lactone compound is 0.2 to 10-fold amount based on the molar amount of the hydroxyl group of the low molecular weight polyvalent alcohol, preferably 0.25 to 5-fold amounts and more preferably 0.3 to 3-fold amounts. When the molar amount of the lactone compound based on the molar amount of the hydroxyl group is less than 0.2-fold amount, the resin is hardened to lower the impact resistance of a coating film and when it is more than 10-fold amounts, the hardness of the coating film is deteriorated.

The carboxylic group-containing polyester resin (b) used for the thermosetting resin composition of the present invention has a carboxylic group of 0.8 to 6.3 mmol/g (solid content), preferably 1.7 to 5.4 mmol/g (solid content) and more preferably 2.6 to 4.5 mmol/g (solid content) and a number average molecular weight of 400 to 3500, preferably 500 to 2500 and more preferably 700 to 2000 and a ratio of weight average molecular weight to number average molecular weight of 1.8 or less, preferably 1.5 or less and more preferably 1.35 or less.

When it is more than 6.3 mmol/g (solid content), the viscosity of the coating composition is too high to induce the lowering of the solid concentration of the coating composition and when the carboxylic group amount is less than 0.8 mmol/g (solid content), the curing property of the coating composition is insufficient. When the molecular weight is more than 3500, the viscosity of the coating composition is too high and handling is difficult to induce the lowering of the solid concentration of the coating composition, and when the molecular weight is less than 400, the curing property of the coating composition insufficient or the water resistance of the coating film is deteriorated. When a ratio of the weight average molecular weight to number average molecular weight is more than 1.8, the water resistance or weather resistance of the coating film is deteriorated.

The half-esterification reaction of the polyester polyol with the acid anhydride group-containing compound can be carried out under usual reaction conditions of room temperature to 150° C. and normal pressure using the acid anhydride group-containing compounds such as phthalic anhydride, tetrahydrophthalic anhydride, hexahydrophthalic anhydride, 4-methylhexahydrophthalic anhydride, trimellitic anhydride and succinic anhydride. However, it is unnecessary to modify all of the hydroxyl groups of the polyester polyol to carboxylic groups, and the hydroxyl group may be left.

Since the carboxylic group-containing polyester resin having hydroxyl groups provides simultaneously the carboxylic groups and hydroxyl groups on the surface of the coating film, for example, when recoating is carried out it provides superior adherence property in comparison with a carboxylic group-containing polyester resin not having a carboxylic group.

In such case, the carboxylic group-containing polyester resin (b) may contain hydroxyl groups and may have an amount of 2.6 mmol/g (solid content) or less, preferably 0.08 to 1.8 mmol/g (solid content) and more preferably 0.18 to 1.4 mmol/g (solid content). When the value of the hydroxyl group is more than 2.6 mmol/g (solid content), the water resistance of the coating film is deteriorated.

Further, since the carboxylic group-containing polyester resin having carboxylic groups and carboxylic groups can be reacted with both of the acryl resin (c) with hydroxyl groups and epoxy groups and the acid anhydride group-containing acryl resin (a) to be bonded, the more hard coating film can be obtained. Those having an average of 0.1 or more hydroxyl group in a molecule are preferable.

In general, the molar amount of the acid anhydride group of the acid anhydride group-containing compound is 0.2 to 1.0-fold based on the molar amount of the hydroxyl group of the polyester polyol and particularly desirably 0.5 to 0.9-fold amount. When the molar amount of the acid anhydride group based on the molar amount of the hydroxyl group is less than 0.2-fold, the curing property of the coating composition obtained is insufficient.

The component of the carboxylic group-containing polyester resin (b) can be compounded at an amount of 5 to 70% by weight, preferably 5 to 50% by weight and more preferably 10 to 40% by weight based on the weight of the total solid in the thermosetting resin composition. When the amount of the carboxylic group-containing polyester resin is less than 5% by weight, the solid concentration of the coating obtained is not increased and when it is more than 70% by weight, the weather resistance of the coating film obtained is deteriorated.

Acryl Resin (c) With Hydroxyl Group and Epoxy Group

The acryl resin (c) with hydroxyl groups and epoxy groups used for the thermosetting resin composition of the present invention can be obtained by copolymerizing a hydroxyl group-containing ethylenically unsaturated monomer and an epoxy group-containing ethylenically unsaturated monomer with an ethylenically unsaturated monomer not having a hydroxyl group and an epoxy group.

The number average molecular weight of the acryl resin obtained is 200 to 10000, preferably 500 to 8000 and more preferably 800 to 5000. When the number average molecular weight is less than 200, the curing property of the coating film is deteriorated and when it is more than 10000, the solid content of the paint obtained is deteriorated.

The amount of the hydroxyl group is 0.08 to 5.4 mmol/g (solid content), preferably 0.17 to 3.6 mmol/g (solid content) and more preferably 0.2 to 2.7 mmol/g (solid content). When the hydroxyl group is more than 5.4 mmol/g (solid content), the solid content of the paint is deteriorated and the water resistance of the coating film cured is not sufficient and when it is less than 0.08 mmol/g (solid content), adherence is inferior. Further, the amount of the epoxy group is 1.2 to 10 mmol/g (solid content), preferably 1.6 to 6.7 mmol/g (solid content) and more preferably 2.0 to 5.0 mmol/g (solid content). When the amount of the epoxy group is less than the lower limit, the curing property of the coating composition is insufficient. Further, when it is larger than the upper limit, it is too hard and is not preferable because the coating film is fragile.

The acryl resin with hydroxyl groups and epoxy groups used in the present invention is an acryl resin obtained by copolymerizing 5 to 70% by weight and preferably 10 to 30% by weight of a hydroxyl group-containing ethylenically unsaturated monomer and 10 to 60% by weight and preferably 15 to 50% by weight of an epoxy group-containing ethylenically unsaturated monomer with 0 to 85% by weight and preferably 10 to 60% by weight of an ethylenically unsaturated monomer not having a hydroxyl group and an epoxy group. When the hydroxyl group-containing ethylenically unsaturated monomer is less than 5% by weight, the curing property is insufficient and when it is more than 70% by weight, water resistance is deteriorated when the coating film is prepared. When the epoxy group-containing ethylenically unsaturated monomer is less than 10% by weight, the curing property is insufficient and when it is more than 60% by weight, it is too hard and weather resistance is insufficient.

As the hydroxyl group-containing ethylenically unsaturated monomer, the hydroxyl group-containing ethylenically unsaturated monomer represented by the formula (I) which is explained in the preparation of the polymer of the component (a) can be mentioned. Further, the example of the epoxy group-containing ethylenically unsaturated monomer includes glycidyl (meth)acrylate, β-methylglycidyl (meth)acrylate, 3,4-epoxycycloheanyl (meth)acrylate, 4-hydroxybutyl acrylate glycidyl ether and the like. In order to obtain the coating composition that indicates the curing property and storage stability in good balance, glycidyl (meth)acrylate is preferably used.

The ethylenically unsaturated monomer not having a hydroxyl group and an epoxy group includes a monomer not affecting the epoxy group which was above-mentioned as the ethylenically unsaturated monomer having no acid anhydride group in order to prepare the acid anhydride group-containing acryl resin. Copolymerization can be also carried out in like manner as the above-description.

In particular, when the hydroxyl group-containing ethylenically unsaturated monomer is used, the adherence, recoating property and the like of the coating film obtained are improved. Further, as described later, the acryl resin (c) with hydroxyl groups and epoxy groups is reacted with the acid anhydride group-containing acryl resin (a) having both functional groups of the hydroxyl group and epoxy group to be bonded; therefore the more robust coating film can be obtained.

The acryl resin (c) with hydroxyl groups and epoxy groups has preferably an average of 2 to 12 and more preferably an average of 3 to 10 of epoxy groups in one molecule and has preferably an average of 0.5 to 10 and more preferably 1 to 8 of hydroxyl groups.

The acryl resin (c) with hydroxyl groups and epoxy groups can be compounded at 10 to 80% by weight, preferably 20 to 70% by weight and more preferably 30 to 65% by weight based on the weight of the total solid in the thermosetting resin composition. When the amount of the acryl resin (c) with hydroxyl groups and epoxy groups is less than 10% by weight, the curing property of the coating film is deteriorated and when it is more than 70% by weight, yellowing resistance is deteriorated.

Thus, the thermosetting resin composition of the present invention is obtained by compounding the acid anhydride group-containing acryl resin (a), the carboxylic group-containing polyester resin (b) and the acryl resin (c) with hydroxyl groups and epoxy groups. In particular, the thermosetting resin composition with high solid content which forms the coating film superior in acid resistance is obtained.

The compounding of the acid anhydride group-containing acryl resin (a), the carboxylic group-containing polyester resin (b) and the acryl resin (c) with hydroxyl groups and epoxy groups can be carried out at amounts and methods which are well known to those skilled in the art.

The compounding is preferably carried out so that the molar ratio of the carboxyl groups contained in the acid anhydride group-containing acryl resin (a) and the carboxylic group-containing polyester resin (b) to the epoxy groups contained in the acryl resin (c) with hydroxyl groups and epoxy groups is 1/1.4 to 1/0.6 and preferably 1/1.2 to 1/0.8 and the molar ratio of the acid anhydride groups contained in the acid anhydride group-containing acryl resin (a) to the hydroxyl groups contained in the carboxylic group-containing polyester resin (b) and the acryl resin (c) with hydroxyl groups and epoxy groups is 1/1.0 to 1/0.1 and more preferably 1/0.9 to 1/0.2.

When the ratio of the carboxyl groups contained in the acid anhydride group-containing acryl resin (a) and the carboxylic group-containing polyester resin (b) to the epoxy groups contained in the acryl resin (c) with hydroxyl groups and epoxy groups is more than 1/0.6, the curing property of the coating composition obtained is deteriorated and when it is less than 1/1.4, the coating film turns yellow. When the molar ratio of the acid anhydride group contained in the acid anhydride group-containing acryl resin (a) to the hydroxyl group contained in the carboxylic group-containing polyester resin (b) and the acryl resin (c) with hydroxyl groups and epoxy groups is more than 1/0.1, curing speed is too fast and defects of appearance occur and when it is less than 1/1.0, water resistance is deteriorated because the curing speed is slow and the hydroxyl group is excessive. Its compounding amount can be calculated from the acid anhydride group, the hydroxyl group, the carboxylic group and the epoxy group by a calculation method which is well known to those skilled in the art.

The curing mechanism of the thermosetting resin composition of the present invention thus obtained forms crosslinking points by firstly reacting the acid anhydride group in the acid anhydride group-containing acryl resin (a) with the hydroxyl group contained in the carboxylic group-containing polyester resin (b) and the acid anhydride group-containing acryl resin (a) by heating, and forms the carboxylic groups again. The carboxylic groups and the carboxylic group existing in the carboxylic group-containing polyester resin (b) form crosslinking points by being reacted with the epoxy group existing in the acryl resin (c) with hydroxyl groups and epoxy groups. Thus, curing proceeds by mutually reacting three kinds of polymers and high crosslinking density can be provided.

Catalyst (d)

An appropriate curing catalyst for promoting the curing reaction can be compounded in the thermosetting resin composition of the present invention. The curing catalyst is usually used for the esterification reaction of epoxy with acid and includes a phosphite compound, quaternary ammonium salts and the like shown below. Respective compounds and salts are explained.

Phosphite Compound

The phosphite compound used in the present invention includes phosphorous acid triester represented by the under-described formula (II) and diphosphorous acid ester represented by the under-described formula (III). 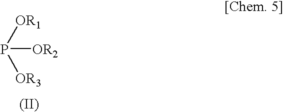
(Wherein R₁, R₂ and R₃ indicate an alkyl group and/or an aryl group.)

In the phosphorous acid triester of the formula (II), as trialkyl phosphite in which R₁, R₂ and R₃ are an alkyl group, there can be used tributyl phosphite, tri(iso-octyl) phosphite, tri(iso-decyl) phosphite, trilauryl phosphite, trioleyl phosphite, tristearyl phosphite, triallyl phosphite and the like; as alkylaryl phosphite in which R₁, R₂ and R₃ of the formula (II) are an alkyl group and an aryl group, there can be used mono(iso-octyl)diphenyl phosphite, mono(iso-decyl)diphenyl phosphite, di(iso-octyl)monophenyl phosphite, di(iso-decyl)monophenyl phosphite and the like; as triaryl phosphite in which R₁, R₂ and R₃ of the formula (VI) are an aryl group, there can be used triphenyl phosphite, tris(p-phenylphenyl) phosphite, tris(ortho-cyclohexylphenyl) phosphite, tris(p-nonylphenyl) phosphite, tri(monononyl/dinonylphenyl) phosphite, phenyl-p-nonylphenyl phosphite, tris(2,4-di-tert-butylphenyl) phosphite and the like. These compounds may be used alone and in combination with two or more thereof. 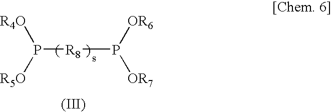
(Wherein R₄, R₅, R₆ R₇ indicate an alkyl group and/or an aryl group, R₈ indicates a phenyl group, a phenylene group or an alkylene group and s is 1 to 5.)

In the diphosphorous acid ester of the formula (III), R₄, R₅, R₆ and R₇ are specifically a compound combining the alkyl group and aryl group similar as those which are used in the above-mentioned formula (II).

The R₈ of the formula (III) is a phenylene group, a biphenylene group and an alkyl group having 1 to 6 carbon atoms.

The example of the preferable diphosphorous acid ester includes triphenyl phosphite, tris(2,4-di-tert-butylphenyl) phosphite, tributyl phosphite, trilauryl phosphite, mono(iso-octyl)diphenyl phosphite, tris(p-nonylphenyl) phosphite and the like and triphenyl phosphite and tris(2,4-di-tert-butylphenyl) phosphite can be particularly preferably mentioned.

The example of the preferable diphosphorous acid ester includes tetrakis(2,4-di-tert-butylphenyl)-4,4′-biphenylene diphosphite.

The phosphite compound is compounded at 0.1 to 5 parts by solid weight based on 100 parts by weight of the resin solid content of the coating composition of the present invention, preferably 0.2 to 4 parts by solid weight and more preferably 0.5 to 3 parts by solid weight. When the compounding amount of the phosphite compound is less than 0.1 part by solid weight, effect of preventing yellowing resistance of the coating film is not obtained and when it is more than 5 parts by solid weight, it is not preferable because the water resistance of the coating film is deteriorated. According to the present invention, the yellowing resistance of the coating film, in particular, yellowing resistance by over baking at the formation of the coating film is greatly improved by forming the coating film with the coating composition obtained, by adding the phosphite compound in the coating composition.

When the phosphite compound is added in the coating composition according to the present invention, oxidation is prevented by the reduction action of the phosphite compound against an epoxy group which is the factor of yellowing in an acid/epoxy curing system and the yellowing of the coating film formed can be remarkably reduced.

Quaternary Ammonium Salt

In addition to the above-mentioned components, the thermosetting resin composition of the present invention may contain a curing catalyst usually used for the esterification reaction of epoxy with acid such as quaternary ammonium salt. The specific example of other catalyst used for the thermosetting resin composition of the present invention includes benzyltriethylammonium chloride or bromide, tetrabutylammonium chloride or bromide, salicylate or glycolate, para-toluene sulfonate and the like. These curing catalysts may be used in mixture.

The quaternary ammonium salt can be used at a compounding amount of 0.1 to 5.0% by weight based on the resin solid content of the thermosetting resin composition, preferably 0.1 to 1.5% by weight and more preferably 0.4 to 1.2% by weight. When the amount of the catalyst used is less than 0.01% by weight, curing property is deteriorated and when it is more than 3.0% by weight, storage stability is deteriorated.

Further, a tin base compound may be used in combination with these as described in JP-A-2-151651 and JP-A-2-279713. The example of the tin base catalyst includes dimethyltin bis(methyl malate), dimethyltin bis(ethyl malate), dimethyltin bis(butyl malate), dibutyltin bis(butyl malate) and the like.

The tin base compound is generally used at a compounding amount of 0.1 to 5.0% by weight based on the resin solid content of the coating composition, preferably 0.1 to 4.0% by weight and more preferably 0.2 to 2.0% by weight. When the amount of the tin base compound used is less than 0.1% by weight, storage stability is deteriorated and when the amount of the tin base compound used is more than 5.0% by weight, weather resistance is deteriorated. When the curing catalyst is used in combination with the tin base compound, the weight ratio of the curing catalyst to the tin base compound is preferably 1/4 to 1/0.2.

Mode of Package

The thermosetting resin composition of the present invention is a two-component, preserved in two packages and used by mixing both before coating. Since the above-mentioned components (a) to (d) are main components, these are divided into two packages, but mutually reactive components cannot be packed into one package. Since the component (c) is the curing agent component of the components (a) and (b), the component (c) must be separated from the components (a) and (b). Accordingly, the components (a) and (b) are usually packed in one package (called as the first package) and the component (c) is packed in another package (called as the second package). The component (d) may be packed in either of packages but it is preferably compounded in the first package in general.

With respect to the timing of mixing two packages, the first package and the second package are mixed just before use to be coated by a usual coating gun. Further, they may be coated by a method of feeding respective liquids to the gun with a two liquid mixing gun and mixing them at the edge of the gun.

Other (Arbitrary) Component

Blocked isocyanate may be also added to the two packages type thermosetting resin composition of the present invention in order to increase the crosslinking density and improve the water resistance. Further, an ultraviolet absorbent, a hindered amine photo stabilizer, an antioxidant and the like may be added for improving the weather resistance of the coating film. Crosslinking resin particles as a rheology control agent and a surface control agent for controlling appearance may be added. Furthermore, alcohol base solvents (for example, methanol, ethanol, propanol, butanol and the like) and solvents such as hydrocarbon base and ester base may be used as a diluent for controlling viscosity and the like.

When the crosslinking resin particles are used, they are added at an amount of 0.01 to 10 parts by weight based on 100 parts by weight of the resin solid content of the thermosetting resin composition of the present invention and preferably 0.1 to 5 parts by weight. When the addition amount of the crosslinking resin particles is more than 10 parts by weight, appearance is deteriorated and when it is less than 0.01 part by weight, rheology control effect is not obtained.

The present invention provides also a coating composition containing the thermosetting resin composition as a binder component. The manufacturing method of the coating composition of the present invention is not specifically limited and all methods which are known to those skilled in the art can be used.

The thermosetting resin composition of the present invention may contain a coloring pigment. As the coloring pigment, for example, an organic pigment and an inorganic pigment are mentioned. A filler pigment and further, flake-like pigments such as aluminum powder and mica powder may be used in combination.

Coating Film Forming Method

The coating film forming method of the present invention is a laminated coating film forming method comprising a step of forming an under coating film such as electrodeposition coating film on a coated article, then forming a intermediate coating film by a intermediate coating paint to be cured, then coating a base coating film by an aqueous base or a solvent base paint on a substrate; a step of coating the thermosetting resin composition of the present invention thereon without curing the base coating film; and a step of curing the base coating film and the clear coating film by heating. The thermosetting resin composition is a two packages type thermosetting resin composition, wherein a main agent containing the acid anhydride group-containing acryl resin (a) and the carboxylic group-containing polyester resin (b) and a curing agent containing the acryl resin (c) with hydroxyl groups and epoxy groups are mixed to be controlled before coating so that the equivalent ratio of an acid anhydride group contained in the main agent to an epoxy group component contained in the curing agent is 2/1 to 1/2.

The coating film forming method of the present invention can be advantageously used for various substrates, for example, metal, a plastic, a foam and the like and in particular, metal surface and a cast, but can be particuarly preferably used for a metal product to which cation electrodeposition coating can be carried out. The example of the metal products includes iron, copper, aluminum, tin, zinc and the like and alloys including these metals. Specifically, automobile bodies and parts such as an automobile, an autotruck, an autobicycle and a bus are mentioned. These metals which are preliminarily treated with phosphate, chromate and the like are particuarly preferable.

As electrodeposition paint forming the above-mentioned under coating film, a cation type paint or anion type paint can be used, but the cation type electrodeposition paint composition provides a laminated coating film superior in anticorrosion property.

The intermediate coating paint forming the intermediate coating film contains various organic and inorganic pigments, filler pigments and the like, a coating film forming resin and a curing agent and the like. The intermediate coating film covers the substrate, secures (improve appearance) surface flatness after over coating and can provide the physical properties of the coating film (impact resistance, chipping resistance and the like).

The example of a coloring pigment used for the intermediate coating paint includes an organic pigment and an inorganic pigment. A filler pigment and further, flake-like pigments such as aluminum powder and mica powder may be used in combination. The intermediate coating paint in which carbon black and titanium dioxide are main pigments is used on the standard scale. Further, a so-called color intermediate coating paint which combines set gray matching brightness or hue with the over coating color can be also used.

The coating film forming resin used for the intermediate coating paint is not specifically limited and an acryl resin, a polyester resin, an alkyd resin, an epoxy resin, a urethane resin and the like can be used. These are used in combination with a curing agent such as an amino resin and/or a blocked isocyanate resin. The combination of an alkyd resin and/or a polyester resin with an amino resin is preferable from the viewpoint of pigment dispersion or workability.

When the base coating film is coated on an automobile car body, air electrostatic spray coating or multi stage coating by a rotational spray electrostatic coating machine that is commonly called as “μμ bell”, “μ bell” or “metabell” or the like, or two stage is preferably used for enhancing design property.

In the coating film forming method of the present invention, the clear coating film coated after forming the base coating film is formed for smoothing and protecting the unevenness, flickering and the like originated in brilliant pigment contained in the base coating film. As the coating method, the coating film is specifically formed preferably by the rotational spray electrostatic coating machine such as μμ bell and μ bell which was previously described.

The dry film thickness of the clear coating film formed by the clear paint is changed depending on desired use, but is often 10 to 80 μm and more preferably about 20 to 60 μm. When it is more than the upper limit, sharpness is deteriorated and trouble such as mottling, pin holes or sagging occurs occasionally. When it is less than the lower limit, the grounding cannot be covered and non-continuous coating is generated.

Cured coating film with the degree of high crosslinking is obtained by setting curing temperature for curing the coating film after the coating of the clear coating film at 80 to 180° C. and preferably 120 to 160° C. When it is more than the upper limit, the coating film is hard and brittle and when it is less than the lower limit, curing is not adequate. The curing time is changed depending on the curing temperature, but is appropriate for 5 to 15 minutes and preferably for 7 to 10 minutes at 120 to 160° C. The thermosetting resin composition of the present invention has significance on effect by shortening the conventionally general curing time of 18 to 20 minutes to 5 to 15 minutes.

The film thickness of the laminated coating film formed in the present invention is 30 to 300 μm in many cases and preferably 50 to 250 μm. When it is more than the upper limit, film physical properties such as cooling and heating cycle are deteriorated and when it is less than the lower limit, the strength of the film itself is deteriorated.

### EXAMPLES

The present invention is more specifically explained according to Examples. The present invention is not limited to these Examples.

### Synthesis Example 1

Synthesis of Acid Anhydride Group-containing Acryl Resin (Component (a))

46.5 Parts by weight of propylene glycol monomethyl ether acetate and 51.8 parts by weight of Solvesso 100 (manufactured by EXXON Mobil Yugen Kaisha Chemical Division, aromatic hydrocarbon solvent) were charged in a reactor equipped with a thermometer, a stirrer, a cooling tube, a nitrogen introducing tube and a dropping funnel and the mixture was raised to 130° C. 16.4 parts by weight of styrene monomer, 18.86 parts by weight of n-butyl acrylate, 7.7 parts by weight of isobornyl acrylate, 22.53 parts by weight of cyclohexyl methacrylate, 13.94 parts by weight of 2-ethylhexyl acrylate, 18 parts by weight of maleic anhydride, 2.57 parts by weight of acrylic acid and a solution comprising 8.5 parts by weight of tert-butylperoxy 2-ethylhexanoate and 5.2 parts by weight of Solvesso 100 were added dropwise in the above-mentioned container over 3 hours using a dropping funnel. After completion of the dropwise addition, the mixture was retained at 130° C. over 30 minutes and then, a solution comprising 1 part by weight of tert-butylperoxy 2-ethylhexanoate and 2.2 parts by weight of Solvesso 100 was added dropwise for 30 minutes. After completion of the dropwise addition, the reaction was continued at 130° C. for one hour to obtain varnish with nonvolatile matter of 58% which contains the acid anhydride group-containing acryl resin with a number average molecular weight of 3100 and an acid anhydride group of 1.84 mmol/g (solid content).

### Synthesis Example 2

Synthesis of Carboxylic Group-containing Polyester Resin (Component (b))

8.85 parts by weight of pentaerythritol, 57.5 parts by weight of PLACCEL M (Trade name, manufactured by Daicel Chemical Industries Ltd., ε-caprolactone monomer), 33.92 parts by weight of RIKACID HH-A (Trade name, manufactured by New Japan Chemical Co., Ltd., hexahydrophthalic anhydride) and 0.1 part by weight of dibutyltin oxide were charged in a reactor equipped with a thermometer, a stirrer, a cooling tube and a nitrogen introducing tube and the mixture was raised to 150° C.

After the mixture was retained at 150° C. over 2 hours, 616 parts by weight of hexahydrophthalic anhydride which was dissolved by heating was added, the mixture was retained at 150° C. for one hour, then cooled and diluted with 33.4 parts by weight of 3-ethoxyethyl propionate to obtain varnish with nonvolatile matter of 75% which contains the carboxylic group-containing polyester resin with a number average molecular weight of 2500, a ratio of weight average molecular weight to number average molecular weight of 1.3, a carboxyl group of 2.2 mmol/g (solid content) and a hydroxyl group of 0.32 mmol/g (solid content).

### Synthesis Example 3

Synthesis of Acryl Resin With Hydroxyl Groups and Epoxy Groups (Component (c))

23.7 parts by weight of 3-ethoxyethyl propionate was charged in an autoclave equipped with a thermometer, a stirrer, a cooling tube, a nitrogen introducing tube and a dropping funnel and the mixture was raised to 170° C.

25 parts by weight of styrene, 30.3 parts by weight of glycidyl methacrylate, 8 parts by weight of n-butyl acrylate, 23.9 parts by weight of isobornyl acrylate, 12.8 parts by weight of 4-hydroxybutyl acrylate and a solution comprising 3.0 parts by weight of di-tert-amyl peroxide and 2.6 parts by weight of 3-ethoxyethyl propionate were added dropwise in the above-mentioned reactor over 3 hours using a liquid delivery pump.

After completion of the dropwise addition, the mixture was retained at 170° C. over 30 minutes, a solution comprising 0.4 part by weight of di-tertert-butyl peroxide and 1.5 parts by weight of 3-ethoxyethyl propionate was added dropwise over 30 minutes using a liquid delivery pump.

After completion of the dropwise addition, the reaction was continued at 170° C. for one hour to obtain varnish with nonvolatile matter of 76% which contains the acryl resin with a number average molecular weight of 2200, an epoxy group of 2.1 mmol/g (solid content) and a hydroxyl group of 0.9 mmol/g (solid content).

### Synthesis Example 4

Synthesis of Acryl Resin With Epoxy Groups

23.7 parts by weight of 3-ethoxyethyl propionate was charged in an autoclave equipped with a thermometer, a stirrer, a cooling tube, a nitrogen introducing tube and a dropping funnel and the mixture was raised to 170° C.

25 parts by weight of styrene, 30.3 parts by weight of glycidyl methacrylate, 19.67 parts by weight of n-butyl acrylate, 25.03 parts by weight of isobornyl acrylate and a solution comprising 3.0 parts by weight of di-tert-amyl peroxide and 2.6 parts by weight of 3-ethoxyethyl propionate were added dropwise in the above-mentioned reactor over 3 hours using a liquid delivery pump.

fter completion of the dropwise addition, the mixture was retained at 170° C. over 30 minutes, a solution comprising 0.4 part by weight of di-tertert-butyl peroxide and 1.5 parts by weight of 3-ethoxyethyl propionate was added dropwise over 30 minutes using a liquid delivery pump.

After completion of the dropwise addition, the reaction was further continued at 170° C. for one hour to obtain varnish with nonvolatile matter of 76% which contains the acryl resin with a number average molecular weight of 2350 and an epoxy group of 2.1 mmol/g (solid content).

### Synthesis Example 5

Synthesis of Polyacrylic Acid Resin

46.5 parts by weight of propylene glycol monomethyl ether acetate and 51.8 parts by weight of Solvesso 100 (manufactured by EXXON Mobil Yugen Kaisha Chemical Division, aromatic hydrocarbon solvent) were charged in a reactor equipped with a thermometer, a stirrer, a cooling tube, a nitrogen introducing tube and a dropping funnel and the mixture was raised to 130° C. 16.45 parts by weight of styrene monomer, 37.84 parts by weight of n-butyl acrylate, 16.45 parts by weight of isobornyl acrylate, 13.46 parts by weight of cyclohexyl methacrylate, 15.8 parts by weight of acrylic acid and a solution comprising 8.5 parts by weight of tert-butylperoxy 2-ethylhexanoate and 5.2 parts by weight of Solvesso 100 were added dropwise in the above-mentioned container over 3 hours using a dropping funnel. After completion of the dropwise addition, the mixture was retained at 130° C. over 30 minutes and then, a solution comprising 1 part by weight of tert-butylperoxy 2-ethylhexanoate and 2.2 parts by weight of Solvesso 100 was added dropwise for 30 minutes. After completion of the dropwise addition, the reaction was continued at 130° C. for one hour to obtain varnish with nonvolatile matter of 58% which contains a polyacrylic acid resin with a number average molecular weight of 2600 and a carboxyl group of 2.2 mmol/g (solid content).

### Examples 1 to 3

Preparation of Thermosetting Resin Composition

The acid anhydride group-containing acryl resin (component (a)) obtained in Synthesis Example 1, the carboxylic group-containing polyester resin (component (b)) obtained in Synthesis Example 2 and 0.5 part by weight of tetrabutylammonium bromide curing catalyst were mixed at the compounding shown in Table 1 to prepare the first package. The acryl resin (component (c)) obtained in Synthesis Example 3, 2 parts of an ultraviolet absorbent “TINUVIN 900” manufactured by Ciba Specialty Chemicals, 1 part of a photo stabilizer “SANOL LS-440” manufactured by Sankyo Lifetech Co., Ltd. and 1 part by weight of a surface controlling agent “MODAFLOW” manufactured by UCB Co. were mixed to prepare the second package. When 2 liquids are preserved in this state, they are not reacted under condition of room temperature. The first package and the first package which were obtained above were mixed just before use to adjust viscosity at 28 seconds by Ford Cup No.4 with a ratio of mix solvent comprising butyl acetate to xylene of 1/1 to be used for coating.

Formation of Coating Film

An aqueous paint (Trade name; “AR-2000 SILVER METALLIC” manufactured by Nippon Paint Co., Ltd.) was applied with an air spray so that the thickness of dry coating film was about 16 μm on step test boards that were obtained by respectively coating a cation electrodeposition paint (Trade name; “POWER TOP U-50” manufactured by Nippon Paint Co., Ltd.) and a middle paint (Trade name; “ORGA P-2” manufactured by Nippon Paint Co., Ltd.) on phosphoric acid processing steel plates with a thickness of 8 mm so as to be a dry thickness of 25 μ and 40 μm, and base coating films were formed by pre-heating at 80° for 5 minutes.

The thermosetting resin composition whose viscosity was adjusted was coated so that dry film thickness was about 40 μm and it was baked at 140° C. for 9 minutes after setting for about 7 minutes. Further, the same one sample was prepared and was baked at 150° C. for 9 minutes. The curing property (solvent resistance and acid resistance) and appearance (flip-flop property (FF property), flatness and striking property) of two coating films obtained were evaluated. The result is shown in Table 1.

Evaluation method was as below.

Solvent Resistance

About 0.2 ml of xylene was added dropwise on the surface of samples with a micro pipette and they were left alone at 20° C. for 30 minutes. After leaving them alone for 30 minutes, residual xylene was wiped off and the state of the coating films after 24 hours was visually evaluated.

Evaluation was as below.
x: Those in which swelling and shrinkage were remarkable.
Δ: Those in which swelling and shrinkage were confirmed.
∘: Those without defects.
   Acid Resistance

0.5 ml of aqueous solution of 40% by weight of sulfuric acid was added dropwise on the surface of samples with a micropipette and they were heated at 60° C. for 15 minutes by a hot-air dryer. After heating them alone for 15 minutes, the samples were washed with water and were visually evaluated. Evaluation was as below.
x: Those in which blem, whitening and swelling were remarkable.
Δ: Those in which blem was confirmed.
∘: Those without defects.
   Flip-flop Property (FF Property)

It was evaluated by the ratio of L values at 25° (high light) and 75° (shade) of the acceptance angle of a spectral calorimeter “CM-512M3 (Trade name)” manufactured by KONIKA MINOLTA HOLDINGS, INC. Further, coating color evaluated was silver tint color and the L value of the acceptance angle of 25° (front) was about 105. Evaluation was as below.
x: Those in which the ratio of L values at 75° to 25° was 2.2.
Δ: Those in which the ratio of L values at 75° to 25° was 2.2 to 2.5.
∘: Those in which the ratio of L values at 75° to 25° was 2.5.
   Flatness

Flatness was visually judged. Evaluation was as below.
x: Wrinkle and shrinkage existed and gloss feeling was inferior.
Δ: Flatness was good, but narrow unevenness (plain feeling) was observed and gloss feeling was inferior.
∘: Flatness was good and feeling gloss was good.
   Striking Property

Formation of Base Monolayer Coating Film for Comparison

The intermediate coating boards which were prepared by the similar procedure as the coating film forming method of the prior Examples was coated with the same base paint by the method similar as prior Examples so that the thickness of dry films was the same, and coated boards with only the base coating film (without the clear coating film) were prepared. Then, pre-heating and baking were carried out at the same condition as Examples to prepare the laminated coating films of a base single layer.

Evaluation Method

Color difference (ΔL) for the laminated coating films of Examples which were obtained by a 2 coats 1 bake coating method (clear paint was coated on the base coating film by wet-on-wet) was measured using the base monolayer coating film as a basis and measured with the spectral calorimeter “CM-512M3 (Trade name)” manufactured by KONIKA MINOLTA HOLDINGS, INC., and the value of the color difference was set as the evaluation of striking property. It is indicated that the smaller the value is, the more superior the striking property.

Judgment Basis

∘: The value of ΔL is 0.5 or less.
Δ: The value of ΔL is more than 0.5 and is not more than 2.
x: The value of ΔL is more than 2.

### Comparative Example 1

Operation was carried out in like manner as Examples except that the compounding amount of the component (a) was 49% by weight and the compounding amount of the component (c) was 51% by weight without using the carboxylic group-containing polyester resin of the component (b), and the coating film was evaluated. The result is shown in Table 1.

### Comparative Example 2

Operation was carried out in like manner as Examples except that the polyacrylic acid of Synthesis Example 5 was used by 49% by weight without using the components (a) and (b), and the coating film was evaluated. The result is shown in Table 1.

### Comparative Example 3

The example is an example near to U.S. Pat. No. 4,816,500 which is a prior example.

Operation was carried out in like manner as Examples except that the polyglycidyl methacrylate synthesized in Synthesis Example 4 was 51% by weight in place of the components (b) and (c), and the coating film was evaluated. The result is shown in Table 1.

TABLE 1

| | | | Example | | | Comparative Example | | |
|---|---|---|---|---|---|---|---|---|
| | | | 1 | 2 | 3 | 1 | 2 | 3 |
| Resin (component a) of Synthesis | | | 32 | 24 | 44 | 49 | | 49 |
| Example 1 | | | | | | | | |
| Resin (component b) of Synthesis | | | 15 | 25 | 5 | | | |
| Example 2 | | | | | | | | |
| Resin (component c) of Synthesis | | | 53 | 51 | 51 | 51 | 51 | |
| Example 3 | | | | | | | | |
| Resin of Synthesis Example 4 | | | | | | | | 51 |
| Resin of Synthesis Example 5 | | | | | | | 49 | |
| Curing catalyst (TBABr) | | | 0.5 | 0.5 | 0.5 | 0.5 | 0.5 | 0.5 |
| Curing | Curing | Solvent | ∘ | ∘ | ∘ | ∘ | x | ∘ |
| condition | property | resistance | | | | | | |
| 150° C. × | | Acid | ∘ | ∘ | ∘ | ∘ | x | ∘ |
| 9 min | | resistance | | | | | | |
| | Appearance | FF property | ∘ | ∘ | ∘ | ∘ | x | ∘ |
| | | Flatness | ∘ | ∘ | ∘ | x | ∘ | x |
| | | Striking | ∘ | ∘ | ∘ | ∘ | x | ∘ |
| | | property | | | | | | |
| Curing | Curing | Solvent | ∘ | ∘ | ∘ | ∘ | x | Δ |
| condition | property | resistance | | | | | | |
| 130° C. × | | Acid | ∘ | ∘ | ∘ | ∘ | x | Δ |
| 9 min | | resistance | | | | | | |
| | Appearance | FF property | ∘ | ∘ | ∘ | ∘ | x | ∘ |
| | | Flatness | ∘ | ∘ | ∘ | Δ | ∘ | Δ |
| | | Striking | ∘ | ∘ | ∘ | ∘ | x | ∘ |
| | | property | | | | | | |

(Note)
The numeric value of compounding column indicates solid weight.

Viewing Examples and Comparative Examples, adequate curing property and appearance (FF property, flatness and striking property) are obtained at short curing time for 9 minutes at the curing temperature of either of 130° C. or 150° C. in Examples containing the components (a), (b) and (c). It is grasped that adequate performance is exhibited by short curing time which is nearly a half of the curing time of 18 to 20 minutes conventionally used. Further, in Comparative Example 3, appearance is insufficient at a curing temperature of 150° C. in an example in which used an epoxy-containing acryl not containing a hydroxyl group being the conventional technique of an acid/epoxy curing system, and curing is also deteriorated at a curing temperature of 130° C. Comparative Example 2 is an example in which polyacrylic acid was used as acidic matter, but when both of the components (a) and (b) are not used as the acidic matter like the present invention, both of the curing property and appearance are insufficient. Comparative Example 1 is an example in which the carboxylic group-containing polyester resin of the component (b) is not contained, and appearance (flatness) is insufficient.

1. A two packages type thermosetting resin composition comprising:
(a) an acid anhydride group-containing acryl resin having an acid anhydride group of 0.08 to 5.3 mmol/g (solid content) and a number average molecular weight of 500 to 8000 that is obtained by copolymerizing an acid anhydride group-containing ethylenically unsaturated monomer with an ethylenically unsaturated monomer having no acid anhydride group,
(b) a carboxylic group-containing polyester resin having a carboxylic group of 0.8 to 6.3 mmol/g (solid content) and a number average molecular weight of 400 to 3500 and a ratio of weight average molecular weight to number average molecular weight of 1.8 or less that is obtained by reacting an acid anhydride group-containing compound with polyester polyol having 3 or more of hydroxyl groups, and
(c) an acryl resin with hydroxyl groups and epoxy groups having a hydroxyl group of 0.08 to 5.4 mmol/g (solid content), an epoxy group of 1.2 to 10.0 mmol/g (solid content) and a number average molecular weight of 200 to 10000 that is obtained by copolymerizing a hydroxyl group-containing ethylenically unsaturated monomer and an epoxy group-containing ethylenically unsaturated monomer with an ethylenically unsaturated monomer not having a hydroxyl group and an epoxy group.

2. The two packages type thermosetting resin composition according to claim 1, wherein the component (a) is 10 to 70% by weight, the component (b) is 5 to 70% by weight and the component (c) is 10 to 80% by weight (provided that % by weight is a value setting the total solid content weight of the two-components thermosetting resin composition as 100% by weight)

3. The two packages type thermosetting resin composition according to claim 1, wherein the components (a) and (b) are the first package, the component (c) is the second package and both packages are mixed so that the equivalent ratio of an acid anhydride group contained in the first package to an epoxy group contained in the second package is 2/1 to 1/2.

4. The two packages type components thermosetting resin composition according to claim 1, wherein either of the first and the second packages or both contains a curing catalyst (d).

5. A coating film forming method comprising a step of applying an aqueous base or a solvent base paint on an under-coated or middle-coated substrate, a step of coating the two packages type thermosetting resin composition according to claim 1 thereon without curing the base coating film, and a step of curing the base coating film and the two-components thermosetting resin composition by heating.

6. A coated article obtained by the method according to claim 5.

7. A coating film forming method comprising a step of applying an aqueous base or a solvent base paint on an under-coated or middle-coated substrate, a step of coating the two packages type thermosetting resin composition according to claim 2 thereon without curing the base coating film, and a step of curing the base coating film and the two-components thermosetting resin composition by heating.

8. A coating film forming method comprising a step of applying an aqueous base or a solvent base paint on an under-coated or middle-coated substrate, a step of coating the two packages type thermosetting resin composition according to claim 3 thereon without curing the base coating film, and a step of curing the base coating film and the two-components thermosetting resin composition by heating.

9. A coating film forming method comprising a step of applying an aqueous base or a solvent base paint on an under-coated or middle-coated substrate, a step of coating the two packages type thermosetting resin composition according to claim 4 thereon without curing the base coating film, and a step of curing the base coating film and the two-components thermosetting resin composition by heating.
